(19) United States
(12) Patent Application Publication
(10) Pub. No.: US 2009/0160240 A1
(43) Pub. Date: Jun. 25, 2009

(54) ONE WAY WHEEL ASSEMBLY

(75) Inventors: Jason HUANG, Changhua County (TW); David Shih, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: B. Green Technology Co. Ltd., Sioushuei Township (TW)

(21) Appl. No.: 12/250,634

(22) Filed: Oct. 14, 2008

(30) Foreign Application Priority Data
Dec. 25, 2007 (TW) 96150046

(51) Int. Cl. B60B 27/00

(52) U.S. Cl. 301/5.23

(57) ABSTRACT

A one way wheel assembly of the present invention includes a first wheel, a second wheel, and a telescoping device pivotally connected to the first wheel and the second wheel respectively. The telescoping device provides a tolerance that first wheel may move toward the second wheel and touch it. So that, when the first wheel is moved along a direction, away from the second wheel, the first wheel will draw the second wheel through the telescoping device. On the contrary, when the first wheel is moved along an opposite direction, toward the second wheel, the first wheel will touch the second wheel and cause a jam to stop both of the wheels.

### BACKGROUND OF THE INVENTION

1. Field of the Invention

The present invention relates to a running apparatus and more particularly, to a one way wheel assembly.

2. Description of the Related Art

There are many products in the market having one-way wheels to perform specific function. For example, some training machines for training abdominal muscles or children's play car are provided with such one-way wheels. Typically, to avoid wheels running reversely, the conventional one-way wheel is provided with extra mechanism on an axle thereof, for example, one-way bearing or ratchet wheel. These conventional devices for one-way wheel have the common problems including higher cost and higher precision requirement in fabrication that the conventional one-way wheel is expensive. Noise is another problem of the conventional one-way wheels that should be fixed as well.

### SUMMARY OF THE INVENTION

The primary objective of the present invention is to provide a one way wheel assembly with lower price and simple structure.

To achieve this and other objects of the present invention, a one way wheel assembly includes a first wheel, a second wheel and a telescoping device pivotally connected to the first wheel and the second wheel respectively. The telescoping device provides a tolerance that first wheel may move toward the second wheel and touch it. So that, when the first wheel is moved along a direction, away from the second wheel, the first wheel will draw the second wheel through the telescoping device. On the contrary, when the first wheel is moved along an opposite direction, toward the second wheel, the first wheel will touch the second wheel that will cause a jam to stop both of the wheels.

### BRIEF DESCRIPTION OF THE DRAWING

FIG. 1 is a top view of a first preferred embodiment of the present invention;

FIG. 2 is a front view of the first preferred embodiment of the present invention;

FIG. 3 is a top view of a second preferred embodiment of the present invention;

FIG. 4 is a top view of a third preferred embodiment of the present invention;

FIG. 5 is a top view of a fourth preferred embodiment of the present invention; and

FIG. 6 is a top view of a fifth preferred embodiment of the present invention.

### DETAILED DESCRIPTION OF THE INVENTION

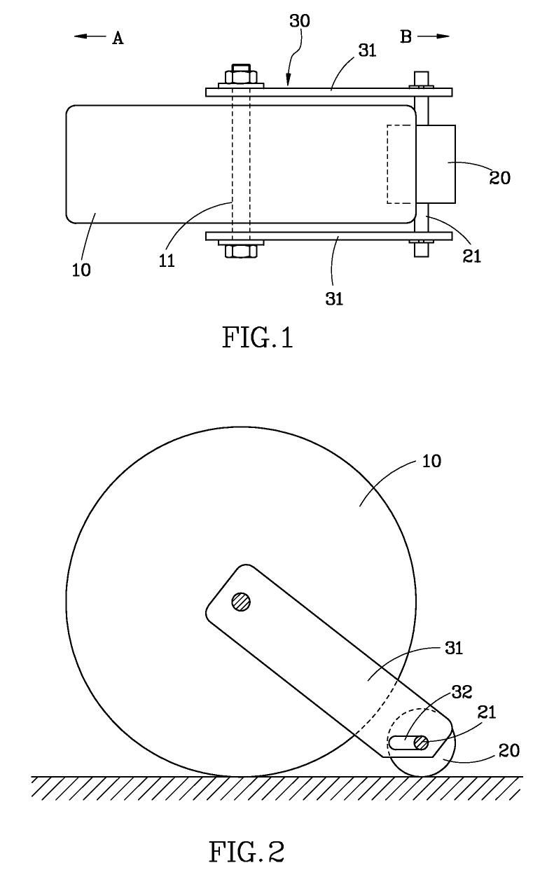

Referring to FIG. 1, a one way wheel assembly of the present invention includes a first wheel 10, a second wheel 20, and a telescoping device 30.

A diameter of the first wheel 10 is greater than that of the second wheel 20. The first wheel 10 has an axle 11, and the second wheel 20 has an axle 21 also.

The telescoping device 30 has an end connected to the axle 11 of the first wheel 10 and the other end connected to the axle 21 of the second wheel 20. Because of the telescoping device 30, a distance between the axles 11, 21 of the first and second wheels 10, 20 will change when the first and second wheels 10, 20 are running. When the first wheel 10 is moved forward, the telescoping device 30 may elongate the distance between the axles 11, 21 that the entire wheel assembly may move freely. When the second is moved forward, the telescoping device 30 narrow the distance between the axles 11, 21 that the second wheel 20 will move toward the first wheel 10, and then touch the first wheel 10 to make both of the first and second wheels 10, 20 can't run.

As shown in FIG. 1 and FIG. 2, in the first preferred embodiment, the telescoping device 30 includes two parallel plates 31 on opposite sides of the first and second wheels 10, 20. Each of the plate 31 has a hole, into which the axle 11 of the first wheel 10 is inserted. Each of the plate 31 further has an elongated slot 32 on opposite side. The axle 21 of the second wheel 20 has opposite ends inserted into the slots 32 of the plates 31 to slide therein. When the first wheel 10 is moved along an arrow A as shown in FIG. 1, the second wheel 20 will be moved along the arrow A through the plates 31, and the axle 21 of the second wheel 20 will be moved to distal ends of the slots 32 of the plates 31 that the distance between the axles 11, 21 of the first and second wheels 10, 20 is elongated, and the entire wheel assembly may run freely. On the contrary, when the first wheel 10 is moved along an arrow B as shown in FIG. 1, the axle 21 of the second wheel 20 will be moved to proximal ends of the slots 32 of the plates 31 that the first wheel 10 will touch the second wheel 20 and cause interference so that the entire wheel assembly will not run. That is, the one way wheel assembly of the fist preferred embodiment of the present invention may run along the arrow A but the arrow B when the first wheel 10 is moved.

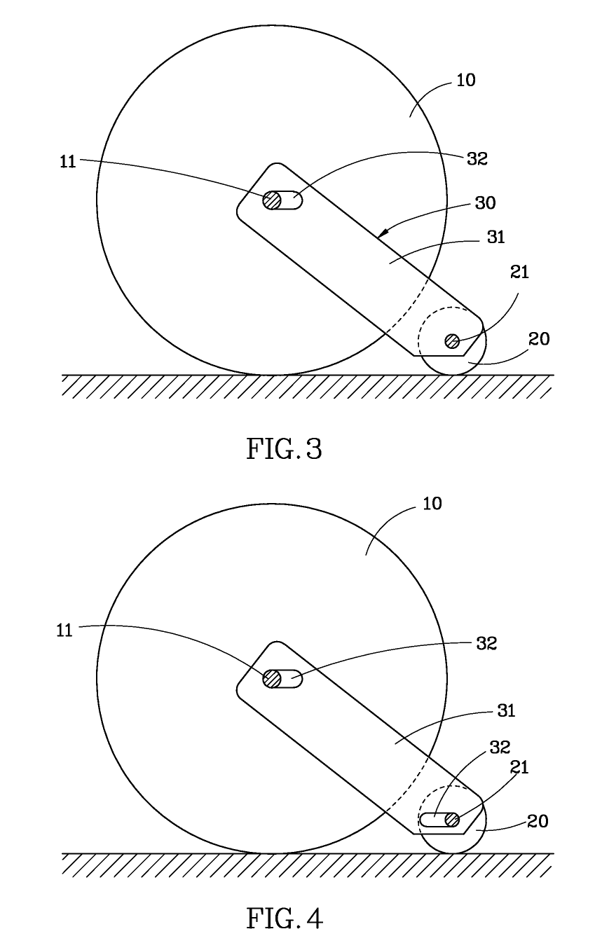

As shown in FIG. 3, the second preferred embodiment of the present invention provides an alternate telescoping device 30 including two parallel plates 31. The different part of the telescoping device 30 of the second preferred embodiment is that slots 32 shifts to the other sides of the plates 31 to be engaged with the axle 11 of the first wheel 10. Same as above, when the first wheel 10 is move along the arrow A, the axle 11 of the first wheel 10 is moved to distal ends of the slots 32 of the plates 31, and the first wheel 10 is moved away from the second wheel 20 that the entire wheel assembly moves freely. On the contrary, when the first wheel 10 is moved along the arrow B, the axle 11 of the first wheel 10 is moved to proximal ends of the slots 32 of the plates 31, and the first wheel 10 is moved toward the second wheel 20 and touches it that the first and second wheels 10, 20 are jammed, and the entire wheel assembly can not run.

FIG. 4 shows the third preferred embodiment of the present invention, in which a telescoping device 30 has two parallel plates 31. Each of the plates 31 has two slots 32 on both sides thereof to be engaged with the axle 11 of the first wheel 10 and the axle 21 of the second wheel 20. The action of the wheel assembly of the third preferred embodiment is as same as above preferred embodiments. When the first wheel 10 is move along the arrow A, the first wheel 10 moves away from the second wheel 20 that the entire wheel assembly moves freely. On the contrary, when the first wheel 10 is moved along the arrow B, the first wheel 10 moves toward the second wheel 20 and touches it that the first and second wheels 10, 20 are jammed, and the entire wheel assembly can not run.

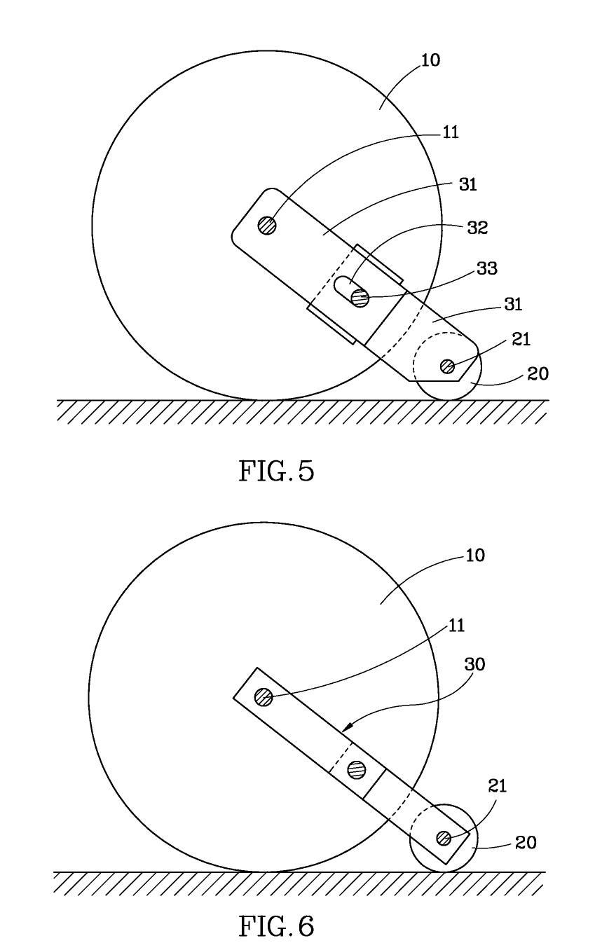

FIG. 5 shows a one way wheel assembly of the fourth preferred embodiment of the present invention having a first wheel 10, a second wheel 20, and a telescoping device 30. The first and second wheels 10, 20 are as same as above. The telescoping device 30 includes two plates connected to the first and second wheels 10, 20. Each of the plates has two sub-plates 31, one of which has an elongated slot 32, and the other of which has a pin 33 inserted into the slot 32 that the plates may change their lengths. Same as above, when the first wheel 10 is move along the arrow A, the telescoping device 30 will be elongated, and the first wheel 10 moves away from the second wheel 20 that the entire wheel assembly moves freely. On the contrary, when the first wheel 10 is moved along the arrow B, the telescoping device 30 will be shortened, and the first wheel 10 moves toward the second wheel 20 and touches it that the first and second wheels 10, 20 are jammed, and the entire wheel assembly can not run.

FIG. 6 shows the fifth preferred embodiment of the present invention, in which a telescoping device 30 has two parallel plates. Each of the plates has two links jointed together. When the first wheel 10 is moved along arrow A, the links will be straightened that the second wheel 20 will be moved along with the first wheel 10. When the first wheel 10 is moved along the arrow B, the links will be bent to shorten the length of the plate that the first wheel 10 moves toward the second wheel 20 and touches it to cause the entire wheel assembly stopped.

The present invention provides a simple, cheaper, and effective structure of the one way wheel assembly with lower noise. It can improve the drawbacks of the conventional device and increases the competitiveness.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A one way wheel assembly, comprising:
a first wheel having an axle;
a second wheel having an axle;
a telescoping device having opposite ends pivotally connected to said axle of said first wheel and said axle of said second wheel respectively;
when said first wheel is moved along a direction which said first wheel moves away from said second wheel, said first wheel moves said second wheel through said telescoping device, and when first wheel is moved along an opposite direction which said first wheel moves toward said second wheel, said telescoping device allows said first wheel touching said second wheel so that said first wheel and said second wheel are stopped.

2. The one way wheel assembly as claimed in claim 1, wherein said telescoping device includes two plates on opposite sides of said first wheel and said second wheel.

3. The one way wheel assembly as claimed in claim 2, wherein each of said plates has a hole and an elongated slot on opposite sides that opposite ends of said axle of said first wheel are inserted into said holes of said plates for free rotation, and opposite ends of said axle of said second wheel are inserted into said elongated slots of said plates for rotation and sliding therein.

4. The one way wheel assembly as claimed in claim 2, wherein each of said plates has a hole and an elongated slot on opposite sides that opposite ends of said axle of said first wheel are inserted into said elongated slots of said plates for rotation and sliding therein, and opposite ends of said axle of said second wheel are inserted into said holes of said plates for free rotation.

5. The one way wheel assembly as claimed in claim 2, wherein each of said plates has two elongated slot on opposite sides that opposite ends of said axle of said first wheel and opposite ends of said axle of said second wheel are inserted into said elongated slots of said plates respectively for rotation and sliding therein.

6. The one way wheel assembly as claimed in claim 2, wherein each of said plates has two sub-plates, one of which has an elongated slot, and the other of which has a pin inserted into said elongated for sliding therein.

7. The one way wheel assembly as claimed in claim 1, wherein said telescoping device includes two links having ends jointed together.

8. The one way wheel assembly as claimed in claim 1, wherein said first wheel is bigger than said wheel.
